(19) United States
(12) Patent Application Publication
(10) Pub. No.: US 2009/0037215 A1
(43) Pub. Date: Feb. 5, 2009

(54) SCREENING METHOD

(75) Inventor: Mark Dale, Hambleton (GB)

Correspondence Address: PATENT INGENUITY, PC, 520 BROADWAY, SUITE 350, SANTA MONICA, CA, 90401, US

(73) Assignee: CLINICAL TRIALS SOFTWARE LTD, Lytham St. Annes (GB)

(21) Appl. No.: 11/833,192

(22) Filed: Aug. 2, 2007

(51) Int. Cl. G06Q 50/00

(52) U.S. Cl. 705/2

(57) ABSTRACT

An automated method of screening a candidate for a clinical trial is disclosed. The method involves processing a drug rule indicative of a criteria associated with at least one drug and a candidiate drug list comprising a list of drugs taken by a candidate. An output is generated, the output being indicative of the candidate's suitability for the clinical trial based upon the processing. The method can be used to screen the candidate prior to the clinical trial. The method can also be used to assess the ongoing suitability of a candidate, while the candidate is participating in the trial.

### BACKGROUND

1. Field

The present disclosure relates to a method of screening a candidate for a clinical trial. More particularly, the present disclosure relates to screening a candidate to determine whether the candidate is suitable for taking part, or to continue participating, in a clinical trial.

2. General Background

When pharmaceutical companies develop a new drug, the drug must be tested in a clinical trial before it can be approved for use on patients. Testing a new drug typically comprises giving the drug to a group of volunteers and observing the effects of the drug on the volunteers. For a clinical trial, the pharmaceutical company will assemble a large group of potential candidates, and choose a subset of that group to take part in the trial. At any one time there may be tens of thousands of clinical trials being conducted worldwide, involving millions of candidates. Pharmaceutical companies may alternatively outsource clinical testing to contract research organizations to administer clinical trials on their behalf. Contract research organizations select, contract with, and monitor clinical trial sites where clinical trial investigators administer drugs to selected candidates. Contract research organizations are responsible for analyzing clinical trial data, reporting to the pharmaceutical companies and liaising with regulatory authorities.

An investigator, sponsor and/or trial site may want to screen candidates e.g. to exclude certain candidates from the trial due to the medication that the candidates are taking. This may be to reduce the risk of side effects occurring due to known (or perceived likely) interactions between the drug being trialed and other drugs that a candidate is taking. Alternatively, this may be because drugs that a candidate is taking could alter the effects of the trial drug, and thus invalidate the results of the clinical trial, thus affecting the clinical data. Candidates may also be excluded due to other factors such as demographic factors including age or gender.

The current method of screening candidates for clinical trials requires the pharmaceutical company to generate a paper list of inclusion and exclusion criteria. For instance, criteria may specify that candidates must be over a predetermined age or must not be taking a particular drug or group of drugs. The inclusion criteria are typically related to the illness that the drug is intended to cure. For a single clinical trial there may be hundreds of relevant inclusion or exclusion criteria. Several clinical trials may be performed simultaneously at a large group of separate clinical trial centers. Once the group of candidates has been assembled they are individually interviewed by a person (a clinical trial investigator) to determine whether they meet the inclusion criteria or any of the exclusion criteria.

The clinical trial investigator is required to repeatedly and manually refer to the inclusion and exclusion criteria when interviewing candidates. This manual method of screening can lead to errors, as it is reliant upon a group of clinical trial investigators deciding whether to include or exclude a particular candidate. As with any activity reliant upon decisions manually taken by a large number of individuals, there is the potential for errors as a result of inaccurate paper-based record keeping and note taking, for instance incorrectly matching a candidate's answers about medication that they are currently taking with the inclusion and exclusion criteria. Furthermore, clinical trials may take place over a period of many months or years during which time clinical trial investigators are required to remember all of the inclusion and exclusion criteria.

During the period of a clinical trial, the Primary Care Physicians of candidates are usually informed of the participation of their patients (if the Primary Care Physicians are not the investigator). Primary Care Physicians are the medical staff, such as doctors, who are normally responsible for the medical health of the candidate e.g. a G.P. (General Practitioner) or hospital doctor. Information is usually provided, in a pen and paper format. This may not be reviewed by all of the Primary Care Physicians e.g. all of the practitioners in a shared surgery. Clinical medications can often be changed by practitioners during the course of a study. The practitioners refer to the information provided in the paper format by the investigator. This is prone to error as the practitioner may not be aware of the study, or may not have read in detail or retained the information. This is a particular problem as practitioners may have patients invoked in many ongoing studies at a time with different investigators.

There are two possible undesirable outcomes that can occur due to errors in manually screening candidates for clinical trials. Firstly, a candidate may be incorrectly included in a trial when they should have been excluded, due to, for instance, the medication that they are currently on. This can have a significant impact on the clinical trial, and those involved in running the clinical trial, should the candidate fall ill or die as a result. Even if the candidate is not adversely affected, their medication may significantly affect the accuracy and reliability of the trial results. Secondly a candidate may be incorrectly excluded from participating in the clinical trial. Delays in clinical trials can delay the progress of gaining authorization to use a new drug for treating patients, and therefore cause the pharmaceutical company to lose sales. This could inadvertently affect the overall health of the world population.

### SUMMARY

In one aspect, an automated method of screening a candidate for a clinical trial is provided. The automated method involves processing a drug rule indicative of a criteria associated with at least one drug and a candidate drug list comprising a list of drugs taken by a candidate. An output is generated indicative of the suitability of the candidate for the clinical trial based upon the processing.

Automating the process of determining whether candidates are suitable for clinical trials can significantly reduce the risk of candidates being incorrectly included in, or excluded from, a clinical trial. The screening can be carried-out prior to the trial and/or as an ongoing process during the trial (e.g. upon each clinical trial visit by the candidate). This improves the safely of candidates by ensuring that those candidates who arc on medication (or have medical conditions) that could adversely interact with the trial drug are reliably excluded from the trial. There are also advantages for those involved in running trials, for instance reductions in the risk of litigation in the event of an error, screening costs, the time spent conducting clinical trials, and improvements in the retention and archiving of records about clinical trials, as well as the accuracy and reliability of the data gained from the trial. Due to the fact that the process of comparing a candidate drug list and the drug rules is automated, administrative staff instead of qualified doctors could carry out parts of a screening method in accordance with embodiments of the present disclosure.

Processing may comprise expanding the drug of the drug rule using a drug database to form a drug rule drug list comprising a list of drug names associated with the drug rule, and comparing the drug rule drug list with the candidate drug list.

The method may further comprise processing a plurality of drug rules, each drug rule being indicative of a criteria associated with at least one drug. Processing may comprise expanding each drug rule separately to form a plurality of drug rule drug lists and comparing each drug rule drug list with the candidate drug list.

A drug rule may be indicative of a category of drugs. Alternatively, a drug rule may be indicative of a drug combination of two or more drugs.

A drug rule may be indicative of an excluded drug. The drug rule drug list is compared with the candidate drug list to determine if the excluded drug is contained within the candidate drug list. If the excluded drug is contained within the candidate drug list, an output indicating that the candidate is not suitable for the clinical trial is generated.

A drug rule may be indicative of an included drug. The drug rule drug list is compared with the candidate drug list to determine if the included drug is contained within the candidate drug list. If the included drug is contained within the candidate drug list, an output indicating that the candidate is suitable for the clinical trial is generated.

In another aspect, a drug rule may be indicative of a minimum dose or a maximum dose of a drug. The drug rule drug list may be compared with the candidate drug list to determine if the candidate has taken the drug above or below either of the minimum dose or maximum dose.

A drug rule may be indicative of a minimum period of time for which a drug has been taken. The drug rule drug list may be compared with the candidate drug list to determine if the candidate has taken the drug for at least the minimum period of time. Similarly, a drug rule may be indicative of a minimum period of time since a drug was last taken, and a comparison may be made to determine if at least the minimum period of time has elapsed since the candidate last took the drug.

The drug database may comprise a plurality of drug records, each drug record relating to a single drug. A drug record may store a plurality of alternative names for the single drug stored in that drug record.

In one aspect, the drug database may be arranged into a plurality of different drug categories, wherein each drug category contains one or more drugs. The drug category may be logically arranged into at least two further drug categories. Each drug record may be associated with one or more drug categories.

The candidate drug list may comprise a drug combination of two or more drugs, the processing comprising expanding the drug combination using the drug database such that the candidate drug list includes two or more individual drugs indicated by the drug combination.

The method may further comprise generating the candidate drug list by beginning to enter part of a drug name within a graphical user interface and selecting one of a plurality of drug names selected from the drug database and displayed within the graphical user interface according to the part of the drug name typed.

The method may further comprise generating the candidate drug list by selecting one of a plurality of drug names selected from the drug database and displayed within a, graphical, user interface.

In a second aspect, the present disclosure provides a carrier medium carrying computer readable code for controlling a computer to carry out the method as described above.

In a third aspect, the present disclosure provides a computer apparatus for screening a candidate for a clinical trial, the apparatus comprising: a program memory storing processor readable instructions; and a processor configured to read and execute instructions stored in the program memory; wherein the processor readable instructions comprise instructions controlling the processor to carry out the method as described above.

In a fourth aspect, the present disclosure provides a method of screening a candidate for a clinical trial, comprising: generating at a first computer a candidate drug list comprising a list of drugs taken by a candidate; transmitting the candidate drug list to a second computer; and receiving at the first computer an output indicative of the candidate's suitability for the clinical trial.

The method may further comprise: processing at the second computer a drug rule indicative of a criteria associated with at least one drug and the candidate drug list; generating at the second computer the output based upon the processing; and transmitting the output from the second computer to the first computer.

The processing may comprise expanding the drug rule using a drug database to form a drug rule drug list which may comprise a list of drugs indicated by the drug rule, and comparing the drug rule drug list with the candidate drug list.

The method may further comprise generating the candidate drug list by beginning to enter part of a drug name within a graphical, user interface and selecting one of a plurality of drug names selected from the drug database and displayed within the graphical user interface according to the part of the drug name typed.

The method may further comprise generating the candidate drug list by selecting one of a plurality of drug names selected from the drug database and displayed within a graphical, user interface.

In a fifth aspect, the present disclosure provides a carrier medium carrying computer readable code for controlling a computer to carry out the method as described above.

In a sixth aspect, the present disclosure provides a computer apparatus for screening a candidate for a clinical trial, the apparatus comprising: a program memory storing processor readable instructions; and a processor configured to read and execute instructions stored in the program memory; wherein the processor readable instructions comprise instructions controlling the processor to carry out the method as described above.

Embodiments of the present disclosure may be implemented in software. For example a carrier medium carrying computer readable code for controlling a computer to carry out the above aspects of the disclosure may be provided. Alternatively, a computer apparatus comprising a program memory storing processor readable instructions and a processor configured to read and execute instructions stored in the program may be provided. The processor readable instructions stored in the program memory may comprise instructions controlling the processor to carry out the above aspects of the disclosure. The computer apparatus may comprise bespoke hardware, specifically a bespoke server arranged to implement the processing of the drug rules and the candidate drug list.

### DRAWINGS

The above-mentioned features and objects of the present disclosure will become more apparent with reference to the following description taken in conjunction with the accompanying drawings wherein like reference numerals denote like elements and in which:

FIG. 1 schematically illustrates a computer network for implementing a screening method in accordance with an embodiment of the present disclosure.

FIG. 2 illustrates in the form of a flow chart a process of defining one or more drug rules in accordance with an embodiment of the present disclosure.

FIG. 3 illustrates in the form of a flow chart a process of verifying one or more drug rules in accordance with an embodiment of the present disclosure.

FIGS. 4A and 4B illustrate in the form of a flow chart a process of generating a candidate drug list in accordance with an embodiment of the present disclosure.

FIG. 5 illustrates in the form of a flow chart a process of validating a candidate drug list by comparing the list to one or more drug rules in accordance with an embodiment of the present disclosure.

### DETAILED DESCRIPTION

An improved screening method suitable for use by pharmaceutical companies or contract research organizations when selecting candidates to undergo clinical trials and/or monitoring the ongoing involvement of candidates in a clinical trial is disclosed herein. A computer-implemented candidate screening system is implemented to replace paper based candidate screening methods for clinical trials. Embodiments of the present system allow pharmaceutical companies or contract research organizations to record details of clinical trials and inclusion and exclusion criteria in a centrally accessible server computer so that clinical trial investigators authorized to access the details for that trial can access the system from anywhere in the world. Medication taken by candidates can be automatically compared with inclusion and exclusion criteria, thus reducing the potential for human error.

During a screening process, drugs that a candidate is currently taking or has recently taken, together with demographic factors relating to the candidate can be compared automatically with a series of inclusion and exclusion criteria which define the criteria that a candidate must meet in order to be considered suitable for taking part in a clinical trial. In one aspect, the inclusion and exclusion criteria comprise one or more drug rules. The drug rules may be defined by, or on behalf of, the pharmaceutical company that developed the drug to be tested. Advantageously, the drug rules allow flexible inclusion and exclusion criteria to be defined, for instance relating to combinations of drugs that are to be included or excluded.

The method can be used to screen the candidate prior to the clinical trial. The method can also be used to assess the ongoing suitability of a candidate, while the candidate is participating in the trial.

Clinical trials may be performed in many different countries. A single drug may have one or more officially recognized names (e.g. the generic name), as well as a translation of the name for each country where a trial is to take place. Each drug could also be identified using its chemical name or full systematic name, which may be abbreviated using a chemical trivial name. Furthermore, each drug may be known by a large number of trade names. Such trade names may also vary from country to country. A drug database in accordance with embodiments of the present disclosure is created, preferably including all known names for each drug within the database. Each unique drug is stored as a separate record within the database together with an associated unique identification (ID) tag. In one embodiment, the ID tag comprises a reference number uniquely assigned to a drug by the Chemical Abstract Service (CAS). The CAS hosts a registry of over 28 million substances, including most if not all common drugs. Thus, if a patient indicates that they are currently taking a drug, referring to the drug by any known name, then this can be matched to the correct record in the drug database.

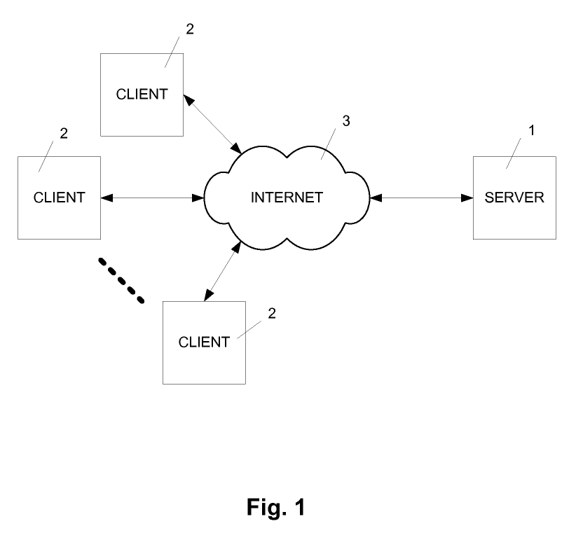

Referring first to FIG. 1, this schematically illustrates an exemplary computer network for implementing a screening system and method in accordance with the present disclosure. A server computer 1 is provided. In one aspect, the server computer 1 is configured to store the drug database. In another aspect, a database which works in communication with the server computer 1 is configured to store the drug database. Server computer 1 also implements a drug validation system responsible for comparing the drug rules (that is the inclusion and exclusion criteria) with a candidate drug list. The candidate drug list is generated by interviewing a candidate and comprises a list of all drugs that a candidate has taken recently. In one aspect, the candidate drug list may also comprise other demographic information. The drug validation system provides an output report detailing the suitability of the candidate for taking part in the clinical trial based upon the comparison. The output report could be automatically generated by the system, and may be in the form of an email, a fax or a letter format suitable for mailing (or a plurality of any of the aforesaid).

A plurality of client computers 2 are provided, each arranged to provide access to the server computer 1 via a computer network 3, such as the Internet. Client computers 2 allow a clinical trial investigator to access the server computer 1, when generating the candidate drug list. The candidate drug list lists the drugs which a candidate is on, or has taken (e.g. within a predetermined time period). The drug database stored on server computer 1 can be used to ensure that drugs within the candidate drug list correspond to a recognized drug (as will be described in greater detail below). Once the candidate drug list is generated, it is transmitted from the client computer 2 to the server computer 1, whereupon the drug validation system compares the candidate drug list with the drug rules.

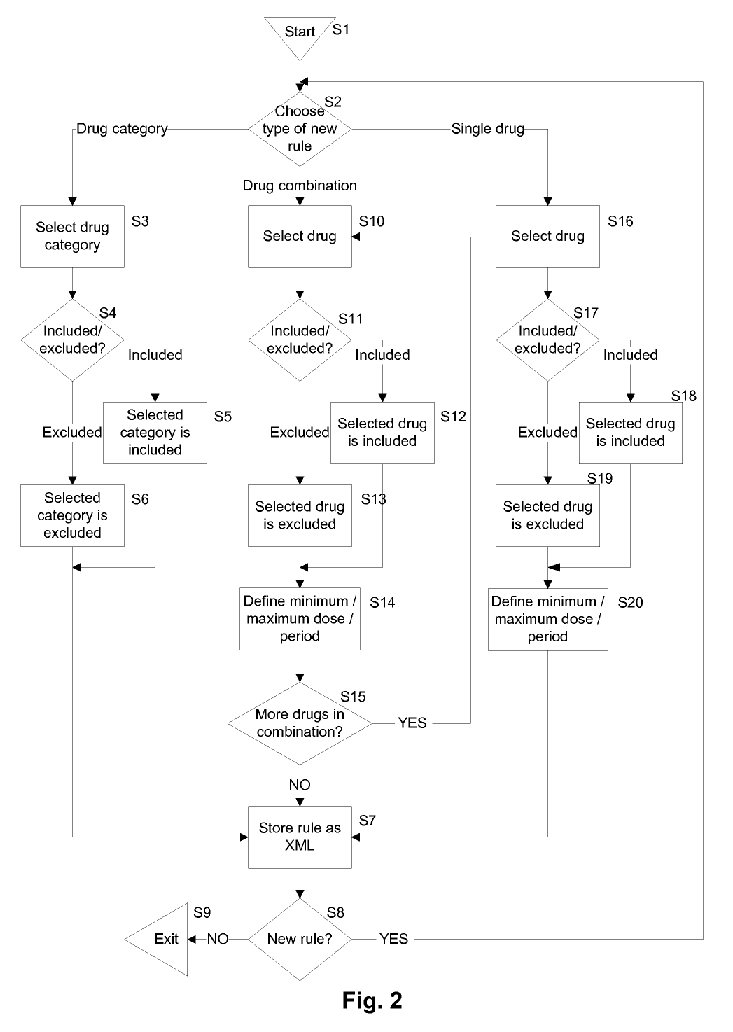

A client computer 2 may also be used by an administrator for maintaining the drug database, particularly in the event that a new drug is identified when preparing a candidate drug list, or for generating the drug rules as will be explained below in combination with FIG. 2.

It will be appreciated that the drug database may alternatively be located in a separate data storage device associated with server computer 1. Furthermore, client computers 2 may alternatively be directly connected to the server computer 1, or via a different form of network 3 such as a local area network (LAN). Alternatively, the server computer 1 and a client computer 2 may be combined into a single computing device.

In one aspect, the screening system and method in accordance with the present disclosure is arranged to assess whether candidates meet the required inclusion or exclusion criteria before participating in a clinical trial. In another aspect, a candidate's status (that is their suitability for the clinical trial) can also be monitored throughout the clinical trial, for instance if there are changes to the drug rules or to the candidate drug list.

As noted above, the drug database is arranged to store each unique drug as a separate record, and to store the name of each drug in a number of translations (according to the country in which a clinical trial is to be performed). Furthermore, for each unique drug the drug database can store trade names, generic names and chemical names such that when generating a candidate drug list if any name is entered the correct drug is identified. In the event that a clinical trial investigator attempts to enter an unknown name of a drug then the drug database can be manually updated by an administrator with the new name, once the correct classification of the drug or an alternative name of the drug has been identified.

In one aspect, drugs within the drug database are stored within a hierarchical structure. For instance a top-level category may be “cardiovascular system”, containing a series of sub-categories including “lipid-regulating drugs”. Each sub-category may include further sub-categories, for instance “statins”. The sub-category “statins” may be a base-level category (that is it contains no further sub-categories), thus containing only a series of individual drugs. There may be any number of levels of category within the hierarchy.

A single drug may appear within more than one category. For instance ‘aspirin” is considered both an “antiplatelet drug” and a “non-steroidal anti-inflammatory drug” and as so, is recorded in both categories. A unique record in the drug database stores each drug, however the record may be referenced by any number of categories. Categories may for example be related to any area or combination of areas, including metabolism, mode of action, or any other system of classification.

Commonly, drugs are dispensed in drug combination containing two or more separate drugs. The hierarchical categories are arranged to take account of this. Each category may contain a reference to a drug combination, such as “triptafen”, which in turn references two or more separate drugs (in this case “amitriptyline hydrochloride” and “perphenazine”). Thus, regardless of the information a candidate provides to a clinical trial investigator, a candidate visit system in accordance with embodiments of the present disclosure is able to identify the constituent drugs, allowing the drug validation system to compare these to each drug rule.

As noted above, drug rules are required to be flexible to cope with complex inclusion and exclusion criteria. Furthermore, in order to be able to accommodate different local requirements when a clinical trial is conducted simultaneously in a plurality of countries, a first set of drug rules are defined as a main trial. A separate sub-trial (separate list of rules) can then be created from this first set for each country in which the clinical trial is to take place allowing the drug rules to be modified as appropriate for local conditions.

Drug rules define the criteria or conditions that are allowable or exempted for a drug (or group of drugs e.g. category), used for defining whether a candidate can be used in a drug trial. Examples of possible drug rules (for any drugs X and Y) include that a patient must:
Not be taking drug X
Be taking drug X
Have been taking drug X for at least Y days
Have stopped taking drug X at least Y days ago
Be taking drug X above a minimum dose
Be taking drug X below a maximum dose
Be taking drug X between a minimum dose and a maximum dose
Be on drug X and drug Y
Be on drug X or drug Y but not both
Any of the above when related to a category of drugs
Any of the above when related to a category of drugs (except for a particular drug, or predetermined selection of drugs within that category)

Typically, a clinical trial comprises a series of separate drug rules. Any one or combination of the above rules could be used for any or each individual drug. Each drug rule could comprise several components. The drug rules may be both additive and hierarchical. That is, simple drug rules may be listed one after another, or arranged in nested loops.

The drug rules can be stored on any computer system using any one of a variety of techniques or languages. For flexibility and extensibility (should more complex drug rules be required in future) the drug rules can be stored in a language such as XML (extensible mark up language). An advantage of storing the drug rules in a single file in XML format is that this simplifies the screening system by ensuring that each trial or sub-trial need only refer to a single drug rules file, rather than multiple separate drug rules files.

The basic structure of a drug rules XML file comprises an outer XML wrapper <DrugRules> followed by a series of individual drug rules each labeled <DrugRule>. Each drug rule is independent of the other drug rules. The following XML fragment illustrates a drug rules file containing two separate drug rules (although the detail of each drug rule is not defined):

<DrugRules>

<DrugRule>
</DrugRule>
<DrugRule>
</DrugRule>

</DrugRules>

When comparing a candidate drug list to the drug rules, each drug rule is processed in the order in which it appears in the drug rules file. Further XML elements include an element to identify a drug category <DrugCategory>, for instance when excluding a whole category of drugs, an element to identify a combination of drugs <DrugCombination>, as well as an element to identify a single drug <Drug>.

Each drug rule specifies one or more included or excluded drugs (or categories and combinations). That is, each drug rule specifies one or more drugs that a patient must or must not be taking. Within the XML file if a drug is included it is given the XML tag <Included>. Conversely, if the drug is excluded it is given the tag <Excluded>. If a given drug is included or excluded in combination with a minimum or maximum dose taken by a candidate then this is indicated by <MinimumDose> or <MaximumDose> respectively. Finally, a period of time in days for which a candidate has been taking, or has not been taking, a drug can be denoted by the element <Period>. For each drug rule, drugs (or combinations and categories) are identified both by the unique drug ID <DrugID> and also by name <DrugName> (which may be any of the names associated with that unique ID). The purpose of identifying the drug by a name as well as by the unique ID is to make the drug rules XML file intelligible to a user should they wish to manually check or amend the drug rules.

The following example relates to a single drug rule for which a combination of two drugs is excluded:

```
<DrugRules>
    <DrugRule>
        <DrugCombinations>
            <Drug>
                <DrugName>Aspirin</DrugName>
                <DrugID>357946</DrugID>
            </Drug>
            <Drug>
                <DrugName>Warfarin</DrugName>
                <DrugID>147963</DrugID>
            </Drug>
        <Excluded>
        </DrugCombinations>
    </DrugRule>
</DrugRules>
```

Drug rules could be generated manually by writing an XML file using a word processing package. However, in accordance with an embodiment of the present disclosure the drug rules are generated using a computer program that prompts a user to enter information about drugs to be included or excluded in order to build up the drug rules. The drug rules are then stored in a single XML file for that clinical trial. As noted above, the drug rules XML file can be modified to take account of differences between countries by creating a separate sub-trial for each country with a corresponding separate drug rules file that can be modified. Each sub-trial inherits the drug rules from a parent trial.

FIG. 2 illustrates in the form of a flow chart the process of generating one or more drug rules. It will be appreciated that in alternative embodiments of the present disclosure more complex drug rules may be defined. The process begins at start step S1 when a user accesses a drug rule builder program. The process then passes to step S2 where a user is prompted to decide whether a first drug rule relates to a drug category, a drug combination, or a single drug. If a drug category is selected then the process passes to step S3.

At step S3 a user is required to indicate the drug category for that drug rule. This may involve a user typing in the name of the category (the system may present possible categories once the first few letters have been typed), or the category may be selected using a drop down menu or series of hierarchical menus, or in any other way.

At step S4 the user is prompted to indicate whether the identified drug category is to be included (that is, a candidate must be taking a drug within that category to be suitable for the clinical trial) or excluded (that is, a candidate must not be taking a drug within that category to be suitable for the clinical trial). If the drug category is to be included then this is recorded at step S5. If the drug category is to be excluded then this is recorded at step S6.

The process then passes to step S7 at which point the first drug rule is stored in XML format. At decision step S8 the user is prompted to indicate whether there are any more drug rules to be entered. If there are more drug rules to be entered then the process passes back to step S2. If not then the process ends at step S9.

If at step S2 a user chooses to select a drug combination for the drug rule then the process passes to step S10. At step S10 a user is required to indicate a first drug within the combination for that drug rule. As for indicating a drug category, this may invoke a user typing in the name of the drug (the system may present possible drugs once the first few letters have been, typed), or the drug may be selected using a drop down menu or series of hierarchical menus, or in any other way.

At step S11 the user is prompted to indicate whether the identified drug is to be included or excluded. If the drug is to be included then this is recorded at step S12. If the drug is to be excluded then this is recorded at step S13.

At step S14 a user is prompted to enter, if appropriate, information about a minimum or maximum dose for that drug and also the length of time a candidate must have been taking the drug (e.g. if it is included) or the length of time since a candidate last took the drug (e.g. if it is excluded).

At step S15 a user is prompted to indicate whether there are more drugs to enter within the drug combination. If there are further drugs to enter then the process passes to step S10 to select a new drug for the combination. If there are no further drugs to enter then the process then passes to step S7.

Finally, if at step S2 where a user chooses to select a single drug for the drug rule then the process passes to step S16. At step S16 a user is required to indicate the drug for that drug rule. At step S17 the user is prompted to indicate whether the identified drug is to be included or excluded. If the drug is to be included then this is recorded at step S18. If the drug is to be excluded then this is recorded at step S19.

At step S20 a user is prompted to enter, if appropriate, information about a minimum or maximum dose for that drug and also the length of time a candidate must have been taking the drug (e.g. if it is included) or the length of time since a candidate last took the drug (e.g. if it is excluded). The process then passes to step S7.

In the process described in combination with FIG. 2, complex and multi-layered drug rules can be defined. Due to the fact that drug rules are defined in XML, the process of FIG. 2 may readily be extended to create significantly more complex and interrelated drug rules. For instance, a whole category of drugs, except for a single particular drug in that category, could be excluded.

After the drug rules have been defined they must be verified at regular intervals to ensure that they remain up to date and take account of any changes in the drug database since the drugs rules were generated. Because the drug rules are stored in XML format, they do not automatically take account of changes to the drug database. The drug rules contain the actual drug (or combination or category) ID number and name, rather than just a reference to the drug database. If a drug is, for instance, withdrawn from use and therefore removed from the drug database, the XML file can become invalid. In order to rectify this, the drug rules file for a trial or a sub-trial is periodically verified.

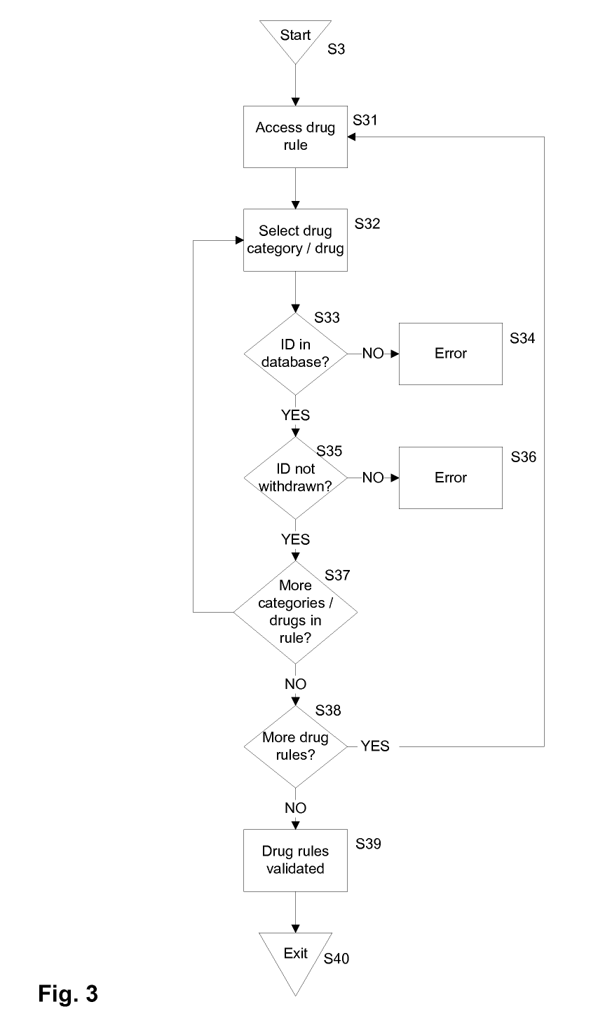

FIG. 3 illustrates a flow chart of a process of verifying a drug rules XML file in accordance with one embodiment of the present disclosure. The process begins at step S30 when drug rule verification is initiated either manually or automatically (for instance after a predetermined time period). The drug rule verification process continues iteratively for each drug rule in turn until all drug rules have been processed. At step S31 a drug rule is accessed. At step S32 the first drug or category within the drug rule is selected for checking.

At step S33 the selected drug or category is checked to see if the drug or drug category ID tag is still in the drug database. It the ID tag is not in the database then the process ends at step S34 by displaying an error message to a user (for instance a database administrator). If the ID tag is in the database then at step S35 a check of the database is made to see whether the drug or drug category have been withdrawn from use. If it has then an error message is displayed to a user at step S36.

At step S37 a check is made to see whether the drug rule contains more drugs or drug categories. If there are then the process returns to step S32 to select the next drug or drug category. Otherwise processing passes to step S38. At step S38, if there are more drug rules to validate then the process returns to step S31, otherwise an output message is generated at step S39 indicating that the drug rules have been successfully validated and the process ends at step S40.

A candidate visit system guides clinical trial investigators though the process of generating a candidate drug list when interviewing a candidate. The candidate visit system comprises a multi lingual software system implemented on a client computer. All data is retained in memory on the client and/or server computer system until the candidate drug list is complete, at which point it is digitally signed, transmitted to the server computer 1 and saved in a database and to an audit trail. The system is arranged to interact with other electronic data capture systems. For example, the system can be utilized in conjunction with, or to support, such systems e.g. by reading or receiving the data (or a part of the data) from such systems, so as to generate the candidate drug list.

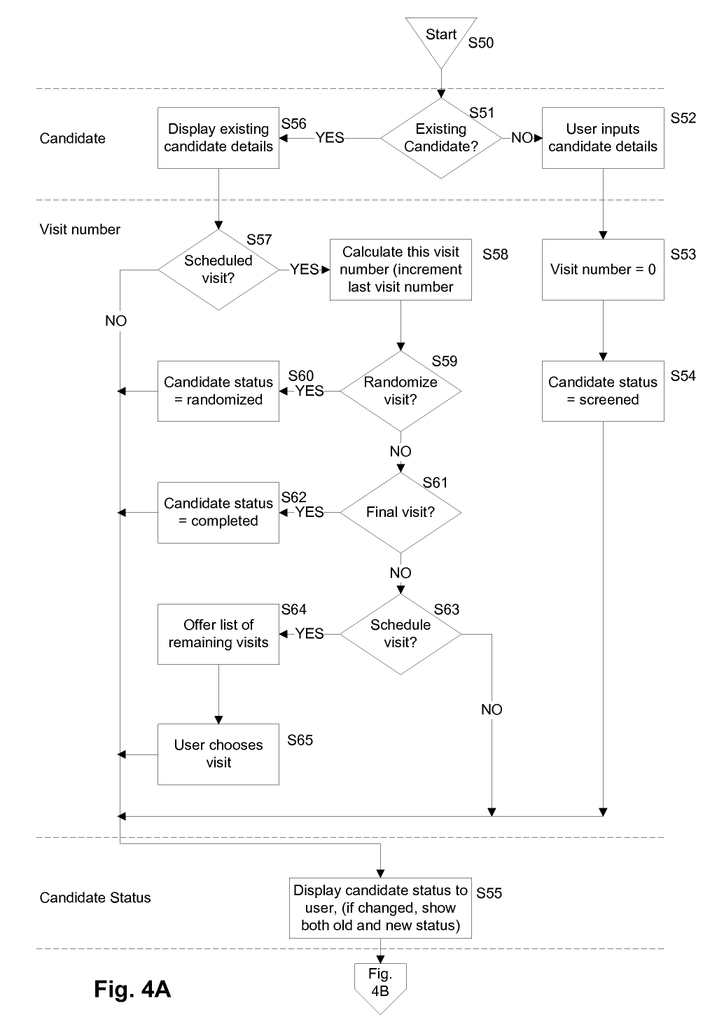

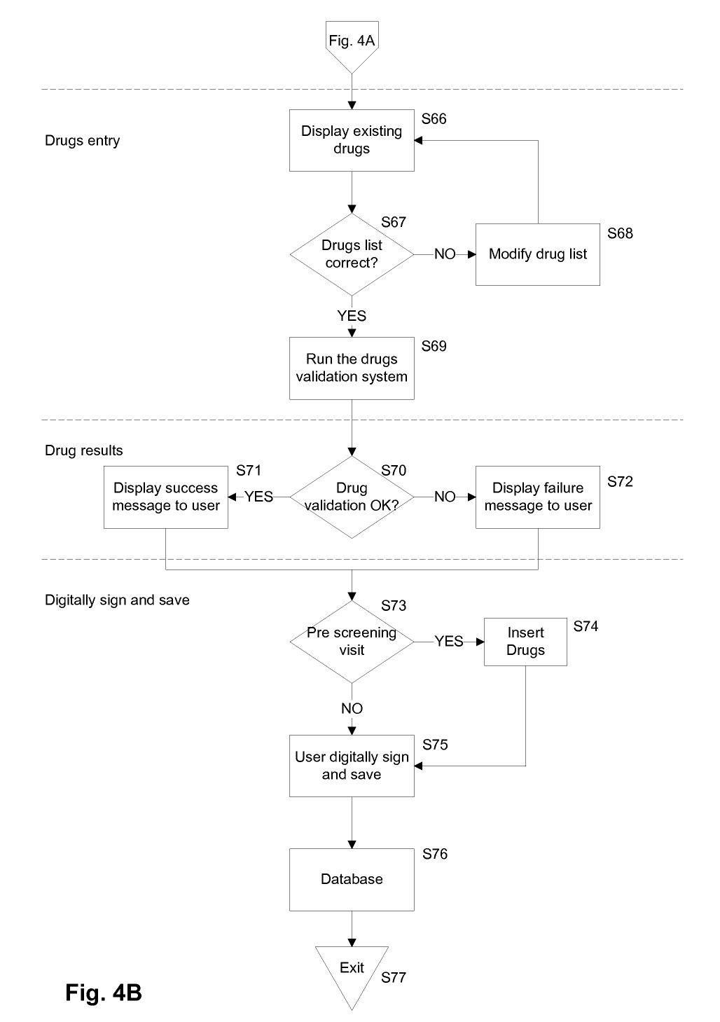

Referring to FIGS. 4A and 4B, these illustrate in the form of a flow chart the process followed by the candidate visit system. The process begins at step S50 when a clinical trial investigator interviews a candidate. At step S51 the clinical trial investigator indicates whether the candidate is a new candidate or whether they ark an existing candidate.

If the candidate is new then at step S52 trial investigator enters the candidate's personal details and demographic information into the system. At step S53 a visit number for that candidate is sot to zero as they have not made any previous visits and at step S54 the candidate status is set to “screened” (that is, they have been entered onto the system). The process then passes to step S55 where the candidate's status is displayed to the clinical trial investigator.

If a candidate is an existing candidate then the process passes from step S51 to step S56 at which point the candidate's existing details are displayed to the clinical trial investigator. At step S57 a check is made to see whether that candidate's visit is scheduled e.g. whether it is a pre-arranged visit, as part of the screening process. The alternative, an unscheduled visit, might arise if a candidate has concerns regarding the screening process, perhaps due to having recently been prescribed new medication. If the visit is unscheduled then the process passes to step S55 to display the candidate's status.

If the visit is scheduled then at step S58 the visit number is incremented. At step S59 a decision is made whether to randomize the visit. For example, in some trials, some (or all) candidates may be selected to undergo a random number of visits, instead of a predetermined number. This step allows the number of future visits by that particular candidate to be randomized, in accordance with predetermined criteria associated with the trial. The candidate's status may be set to “randomizer at step S60, and then displayed at step S55. Otherwise, at step S61 a check is made to see whether this is the last scheduled visit. If it is the last scheduled visit then at step S62 the candidate's status is set to “completed” and displayed at step S55.

At step S63 a check is made to see whether it is necessary to schedule a new visit. If a new scheduled visit is required then at step S64 a list of possible visit times and dates is presented to the candidate and the candidate chooses one at step S65. The process then passes to step S55.

After the candidate's status has been displayed to the clinical trial investigator at step S55, at step S66 a candidate drug list of existing drugs being taken by the candidate is displayed (if these are known from a previous visit). At step S67 the clinical trial investigator checks with the candidate whether it is necessary to amend the candidate drug list. If the candidate drug list is not correct then it is modified at step S68. The process of modifying the candidate drug list comprises the clinical trial, investigator interviewing the candidate to determine what drugs they are taking. This interviewing may be prompted by a series of standard questions. Drugs to be added to the candidate drug list are entered by the clinical trial investigator. The clinical trial investigator may select drugs from a series of hierarchical menus. Drugs from the hierarchical drug database stored on server computer 1 populate the menus. Alternatively, the investigator may begin typing the name of a drug and the candidate visit system presents possible drugs based upon letters typed so far (using information from the drug database). The list of drugs may be presented based on the criteria that the letters entered form part of a common misspelling of a drug or drugs. If the investigator types a name that is not know (and indicates that it is a correct name for a drug not a typographical error) then this triggers a message to a database administrator who can take an appropriate action, such as adding the drug name to the database.

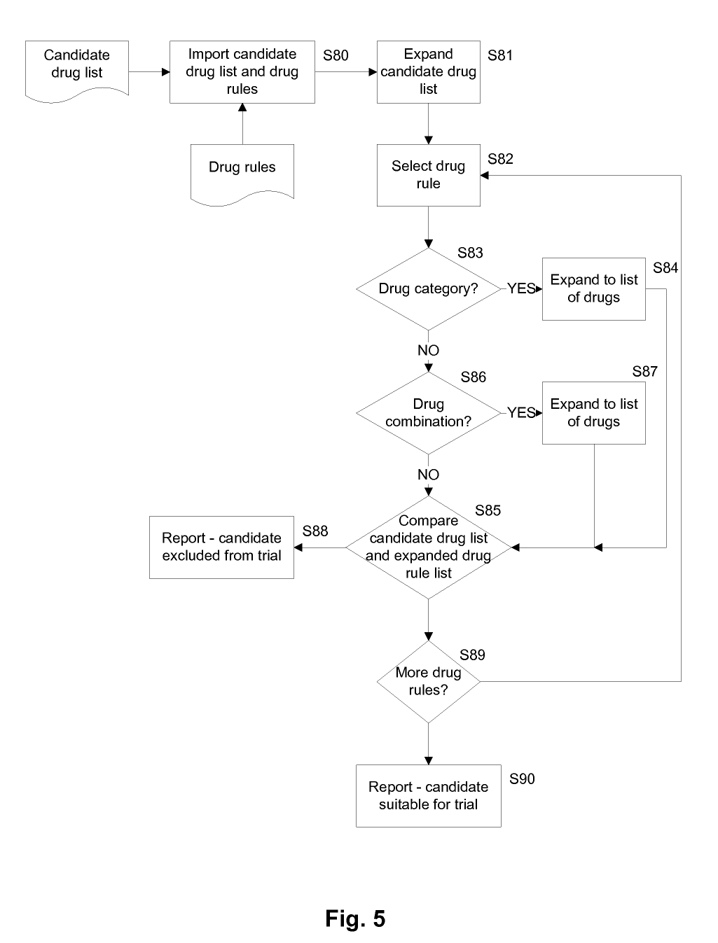

Once the candidate drug list is complete, this list is passed to a drug validation system implemented on the server computer 1 for comparison with the drug rules, at step S69. The drug validation system is described in greater detail below in combination with FIG. 5.

At step S70 a check is made to see whether the candidate drug list is in conformance with the drug rules. If it is, then at step S71 an appropriate success message is presented to the user. Otherwise a failure message is presented to the user at step S72, based upon the output report from the drug validation system.

A check can be made by the system as to whether a particular drug, or set of drugs, is relevant to a protocol i.e. without the drugs being linked to a particular patient. Equally, the data may be linked to a particular patient, but used in an informal mode (as opposed to as part of a clinical trial), with a view to checking whether the drug or multiple drugs/other criteria is relevant to the protocol (e.g. drugs rule series of drug rules). Such a check, in which the data is linked to a particular patient, but only an informal check is made, is termed “pre-screening”. At step S73, a check is made to see whether this candidate visit is for a pre-screening visit. If it is, then the list of relevant drugs (or other criteria) is inserted at step S74.

At step S75 the user digitally signs the candidate drug list and the report from the drug validation system, and this information is transmitted for storage at step S76 in a database associated with server computer 1. The process then ends at step S77.

The purpose of the drug validation system is to compare the drugs that a candidate is taking contained within the candidate drug list with the list of drugs defined by the drug rules for that trial or sub-trial. In order to compare the drug rules with a candidate drug list, the drug rules must be expanded to form a list of drugs (together if appropriate with information regarding dosage and period for which the drug has been taken or not taken) that are included or excluded. For instance, a drug rule excluding a whole category of drugs is expanded to form a list of excluded drugs comprising all of the drugs (within the database) in the category. This may be done iteratively, that is one drug rule expanded and compared at a time.

The drug validation system comprises a separate program implemented by the server computer 1. The drug validation system may be used either as part of a complete system and thus integrated with the candidate visit system. Alternatively, the drug validation system may be provided as a separate program, which can be passed a candidate drug listed created using an alternative candidate visit system and returning a status output. For example, the system could be implemented as a web service.

The drug validation system has two inputs: the candidate drug list (including where relevant, details of dosage and time for which a drug has been taken) and the drug rules XML file. The drug validation system generates a report indicating the status of the candidate. The status may be, for instance, “no drug conflict found”, “candidate is taking an excluded drug” or “candidate is taking a drug over the maximum permitted dose, and thus excluded”. The report is in the form of an XML tile.

Drugs within the candidate drug list are converted from trade names to their full generic name. Furthermore, drug dosage information is standardized (for instance to an equivalent daily dose) and drug combinations and drug categories are expanded to a list of constituent drugs. Each drug rule is expanded to create a list of included or excluded drugs. Each drug that a candidate is taking is compared against each drug within the included and excluded drug lists.

FIG. 5 illustrates a flow chart detailing the process of validating a candidate drug list against the drug rules within a drug validation system in accordance with an embodiment of the present disclosure. The process begins at step S80 by importing both the drug rules XML file and the candidate drug list. At step S81 the candidate drug list is expanded to form a list of separate drugs. At step S82 a first drug rule from the drugs rules file is selected. Each drug rule is assessed separately.

At step S83 a check is made to see whether the drug rule relates to a drug category. If it does, then at step S84 the drug category is expanded to a full list of drugs in that category and the process passes to step S85. Otherwise, processing passes to step S86 and a check is made to see whether the drug rule relates to a drug combination. If the drug rule relates to a drug combination, then processing passes to step S87, in which the combination is expanded to a list of separate drugs, before passing to step S85.

At step S85 the expanded drug rule drug list and the candidate drug list are compared to see if any of the drugs taken by the candidate appear in the excluded drug list or the included drug list. If a candidate is excluded from the clinical trial as a result of the comparison in step S85 then a report identifying this is output at step S88 and the process ends. Otherwise, at step S89 a check is made to see if there are further drug rules to process. If there is a further drug rule then the process returns to step S82. Otherwise, the process ends by outputting a report indicating that the candidate is suitable for the clinical trial at step S90.

Advantageously, clinical trial results may be centrally stored for later use by the pharmaceutical company that sponsored a clinical trial, rather than requiring the collation and processing of large volumes of paper records. Furthermore, due to the fact that the process of validating the drugs that a candidate is taking is performed by a centralized drug validation system, drug rules may be readily amended, and previously successfully screened candidates reassessed in the light of the new drug rules.

The screening system may for example be provided in thee different scenarios. A first scenario is for a fully managed service in which a single organization is responsible for maintaining the drug database, generating the drug rules and screening patients. In a second scenario a first organization is responsible for maintaining the drug database and generating the drug rules, however a second organization is responsible for screening patients and generating candidate drug lists for use within the drug validation system. In a third scenario a first organization maintains the drug database and provides the drug validation system as a stand-alone system that may be accessed by other organizations who provide their own drug rules and candidate drug lists.

Although the above described candidate screening system primarily relates to assessing whether a candidate is suitable for a clinical trial according to a list of drugs that the candidate is taking or is not taking, the present disclosure is not limited to this. The candidate screening system can use any predetermined protocol exclusion and/or inclusion criteria. For instance, candidates may he excluded from clinical trials by other inclusion and exclusion criteria, for instance demographic factors such as age, height, weight, gender and ethic background. Other relevant criteria could relate to health information about the candidate, for instance recent illnesses, chronic medical conditions or family medical background. Such additional inclusion and exclusion may readily be defined within or alongside the drug rules, and the necessary information gathered from candidates when a clinical trial investigator interviews the candidate and included in the candidate drug list.

It should be appreciated that the screening system and method may be used for a variety of purposes. In particular, the system can be used to screen potential candidates at the start, or prior to, the commencement of a clinical trial. Equally, the screening method may be used to screen the candidates involved in a clinical trial throughout the clinical trial to assess and/or monitor the continual eligibility of the candidate. The system can be programmed to read changes in medication(s) performed by Primary Care Physicians during the course of the clinical trial. This can be done automatically, by the system monitoring the computer of the Primary Care Physician, and checking for updates in the drugs of a candidate. The checks could be performed periodically, at predetermined intervals or instances within the trial, or upon the request of a trial investigator. A change in medication to a previously identified patient on the Primary Care Physicians computer runs the screening method and provides output as previously described.

Similarly, the system can also be used in an informal mode, to allow drugs to be checked against a particular profile, or to allow the suitability of a particular candidate/patient to be studied, without the data being taken into consideration during the clinical trial.

The output report of the drug validation system may provide further information beyond a simple statement saying whether the candidate is suitable for the clinical trial or not. For instance, the report may indicate that the candidate is currently excluded but could be included in the trial at some future point after a minimum period of time has elapsed since they last took an excluded drug.

Further modifications and applications of the present disclosure will be readily apparent to the appropriately skilled person as falling within the scope of the present disclosure.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An automated method of screening a candidate for a clinical trial, comprising:
processing a drug rule indicative of a criteria associated with at least one drug and a candidate drug list comprising a list of drugs taken by the candidate; and
generating an output indicative of the suitability of the candidate for the clinical trial based upon the processing.

2. The method of claim 1, wherein the processing comprises expanding the drug of the drug rule using a drug database to form a drug rule drug list comprising a list of drug names associated with the drug rule, and comparing the drug rule drug list with the candidate drug list.

3. The method of claim 1, further comprising processing a plurality of drug rules, each drug rule being indicative of a criteria associated with at least one drug.

4. The method of claim 3, wherein the processing comprises expanding each drug rule separately to form a plurality of drug rule drug lists and comparing each drug rule drug list with the candidate drug list.

5. The method of claim 1, wherein at least one drug rule is indicative of a category of drugs.

6. The method of claim 1, wherein at least one drug rule is indicative of a drug combination of two or more drugs.

7. The method of claim 1, wherein at least one drug rule is indicative of an excluded drug, the comparing comprising determining if the excluded drug is contained within the candidate drug list and generating an output indicating that the candidate is not suitable for the clinical trial if the excluded drug is contained within the candidate drug list.

8. The method of claim 1, wherein at least one drug is indicative of an included drug, the comparing comprising determining if the included drug is contained within the candidate drug list and generating an output indicating that the candidate is suitable for the clinical trial if the included drug is contained within the candidate drug list.

9. The method of claim 1, wherein at least one drug rule is indicative of a minimum dose of a drug, the comparing comprising determining if the candidate has taken the drug above the minimum dose.

10. The method of claim 1, wherein at least one drug rule is indicative of a maximum dose of a drug, the comparing comprising determining if the candidate has taken the drug below the maximum dose.

11. The method of claim 1, wherein at least one drug rule is indicative of a minimum period of time for which a drug has been taken, the comparing comprising determining if the candidate has been taking the drug for at least the minimum period of time.

12. The method of claim 1, wherein at least one drug rule is indicative of a minimum period of time since a drug was last taken, the comparing comprising determining if at least the minimum period of time has elapsed since the candidate last took that drug.

13. The method of claim 1, wherein the drug database comprises a plurality of drug records, each drug record relating to a single drug.

14. The method of claim 13, wherein at least one drug record stores a plurality of alternative names for the single drug stored in that drug record.

15. The method of claim 13, wherein the drug database is arranged into a plurality of different drug categories, wherein each drug category contains one or more drugs.

16. The method of claim 15, wherein at least one drug category is arranged into at least two further drug categories.

17. The method of claim 15, wherein each drug record is associated with one or more drug categories.

18. The method of claim 1, wherein the candidate drug list comprises a drug combination of two or more drugs, the processing comprising expanding the drug combination using the drug database such that the candidate drug list includes two or more individual drugs indicated by the drug combination.

19. The method of claim 1, further comprising generating the candidate drug list by beginning to enter part of a drug name within a graphical user interface and selecting one of a plurality of drug names selected from the drug database and being displayed within the graphical user interface according to the part of the drug name typed.

20. The method of claim 1, further comprising generating the candidate drug list by selecting one of a plurality of drug names selected from the drug database and being displayed within a graphical user interface.

21. The method of claim 1, further comprising checking a remote computer for updates in the drugs of the candidate.

22. An apparatus for screening a candidate for a clinical trial, the apparatus comprising:
a program memory configured to store processor readable instructions; and
a processor configured to read and execute instructions stored in the program memory to process a drug rule indicative of a criteria associated with at least one drug and a candidate drug list comprising a list of drugs taken by the candidate, and generate an output indicative of the suitability of the candidate for the clinical trial.

23. A method of screening a candidate for a clinical trial, comprising:
generating at a first computer a candidate drug list comprising a list of drugs taken by a candidate;
transmitting the candidate drug list to a second computer; and
receiving at the first computer an output indicative of the suitability of the candidate for the clinical trial.

24. The method of claim 23, further comprising:
processing at the second computer a drug rule indicative of a criteria associated with at least one drug and the candidate drug list;
generating at the second computer the output based upon the processing; and
transmitting the output from the second computer to the first computer.

25. The method of claim 24, wherein the processing comprises expanding the drug rule using a drug database to form a drug rule drug list comprising a list of drugs indicated by the drug rule, and comparing the drug rule drug list with the candidate drug list.

26. The method of claim 23, further comprising generating the candidate drug list by beginning to enter part of a drug name within a graphical user interface and selecting one of a plurality or drug names selected from the drug database and displayed within the graphical user interface according to the part of the drug name typed.

27. The method of claim 23 further comprising generating the candidate drug list by selecting one of a plurality of drug names selected from the drug database and displayed within a graphical user interface.

28. An apparatus for screening a candidate for a clinical trial, comprising:
a program memory storing processor readable instructions; and
a processor configured to read and execute instructions stored in the program memory to generate at a first computer a candidate drug list comprising a list of drugs taken by a candidate, transmit the candidate drug list to a second computer; and receive at the first computer an output indicative of the suitability of the candidate for the clinical trial.
